(19) United States
(12) Patent Application Publication
(10) Pub. No.: US 2006/0105293 A1
(43) Pub. Date: May 18, 2006

(54) Dental bur and drilling method using the same

(76) Inventor: Akiyoshi Funato, Kanazawa-shi (JP)

Correspondence Address: THOMPSON HINE L.L.P., P.O. BOX 8801, DAYTON, OH, 45401-8801, US

(21) Appl. No.: 11/270,036

(22) Filed: Nov. 9, 2005

(30) Foreign Application Priority Data
Nov. 16, 2004 (JP) 2004-331803

(51) Int. Cl. A61C 3/02

(52) U.S. Cl. 433/165

(57) ABSTRACT

A dental bur includes a cutting section on one side thereof, a support section on the other side thereof and a neck section connecting the cutting section to the support section. The cutting section has a spherical shape having a predetermined radius. The cutting section is coated with diamond particles.

### BACKGROUND OF THE INVENTION

1. Field of the Invention

The present invention relates to a dental bur for use in dental implantation for placing implants in place of a missing tooth in dental practice.

2. Description of the Related Art

Implantation is known as a restoration technique for a missing tooth in dental treatment. A hole is drilled in a tooth missing portion of the jawbone and an implant is inserted into the hole. An exposed section of the implant out of the jawbone is covered with an upper structure such as an artificial tooth. It is known that the position, depth, and angle of the implant greatly affect the function and the aesthetic quality of the super structure of the implant.

In conventional drilling methods, a hole is drilled using a twist drill from the start of a drilling operation and it is difficult to modify the angle of the hole in the middle of the drilling operation.

Furthermore, in the conventional drilling methods, a dedicated depth gauge is used to measure the depth of the hole. The twist drill and the depth gage are alternately used to measure the depth while performing the drilling operation.

### SUMMARY OF THE INVENTION

Accordingly, it is an object of the present invention to provide a dental bur that relatively easily modifies the angle of a hole and a drilling method for drilling the hole accurately and safely using the dental bur.

In a first aspect of the present invention, a dental bur includes a cutting section on one side thereof, a support section on the other side thereof, and a neck section connecting the cutting section to the support section, the cutting section having a spherical shape and having a predetermined radius and coated with diamond particles.

In a second aspect of the present invention, a dental bur includes a cutting section on one side thereof, a support section on the other side thereof, and a neck section connecting the cutting section to the support section, the cutting section tapered toward the end thereof, terminated in a round shape, and coated with diamond particles.

In the second aspect, the cutting section preferably comprises, on the surface closer to the support section, a first ring area and a second ring area alternately arranged along the longitudinal direction of the cutting section, the first ring area coated with diamond particles and the second ring area uncoated with diamond particles.

In a third aspect of the present invention, a method of drilling a hole receiving an implant, using first, second and third dental burs, includes a step of using the first dental bur, the second dental bur and the third dental bur in that order to drill an initial hole at a planned position in jawbone, wherein the first dental bur comprises at one end thereof a spherical body coated with diamond particles, wherein the second dental bur comprises a cutting section having a tapered portion ended in a spherical shape, the tapered section coated with diamond particles, and wherein the third dental bur has a section tapered at a milder inclination than the second dental bur and ended in a spherical shape, the tapered section coated with diamond particles.

In accordance with embodiments of the present invention, the diamond particles on the cutting section having a cutting function grinds not only the bottom of the hole but also the sidewall of the hole. The angle of the hole is thus relatively easily adjusted. The neck section of the dental bur accommodates water flow, thereby preventing overheating of jawbone in the drilling operation. The neck section also serves as a depth guide of the hole.

Since the cutting section has, on the surface closer to the support section, a first ring area and a second ring area alternately arranged along the longitudinal direction of the cutting section, the first ring area coated with diamond particles and the second ring area uncoated with diamond particles, the ring areas serve the depth guide of the hole. The ring area uncoated with the diamond particles forms a neck portion and holds water in the drilling operation. The overheating of the jawbone is thus further prevented.

In accordance with one embodiment of the present invention, a twist drill is used after the first through third dental burs are used. The hole is thus reliably drilled while the angle of the hole is easily modified.

### BRIEF DESCRIPTION OF THE DRAWINGS

FIGS. 1A-1D illustrate a dental bur of one embodiment of the present invention;

FIGS. 2A-2D illustrate a dental bur of another embodiment of the present invention different from the dental bur of FIGS. 1A-1D;

FIGS. 3A-3D illustrate a dental bur of yet another embodiment of the present invention different from the dental burs of FIGS. 1A-1D and FIGS. 2A-2D.

### DESCRIPTION OF THE PREFERRED EMBODIMENTS

The embodiments of the present invention are described below with reference to the drawings.

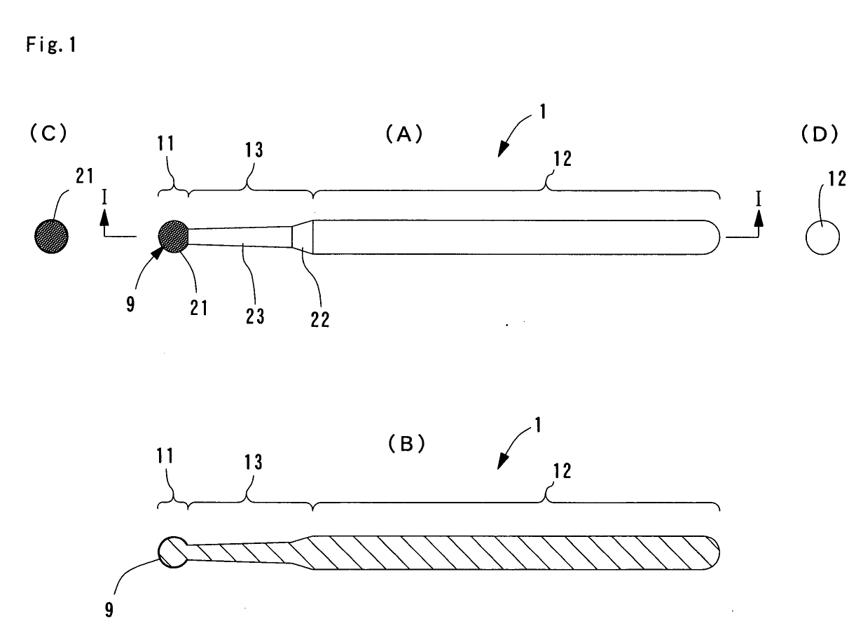

FIGS. 1A through 3D illustrate dental burs of embodiments of the present invention. In the implantation of dental practice, a variety of dental burs is used to drill holes that receive dental implants. The dental burs of FIGS. 1A through 3D illustrate examples of those dental burs. Each dental bur is a drilling instrument having a bar shape and includes, on one side thereof, a cutting section 11 for cutting jawbone and, on the other side, a support section 12 that is connected to a rotary machine.

The dental burs of FIGS. 1A through 3D are constructed of a base material such as stainless steel and the end portion of the cutting section 11 has a spherical shape. The cutting section 11 is coated with diamond particles and a neck section 13 which is formed narrow is arranged between the cutting section 11 and the support section 12.

In the drilling operation, the support section 12 is connected to the rotary machine and the dental bur is rotated with the axis thereof serving as the axis of rotation. Not only the end of the cutting section 11 but also the outer circumference of the cutting section 11 cuts jawbone. The neck section 13 serves as a guide of the depth of the hole in the drilling operation while also serving as a water flow storing portion. During the drilling operation, the depth of the hole is learned without using the depth gauge while heating due to bone cutting is prevented.

The structure of the dental bur is described more in detail below.

FIG. 1A is a plan view of the dental bur 1 of one embodiment of the present invention. FIG. 1B is a sectional view of the dental bur 1 taken along line I-I in FIG. 1A. FIG 1C is an end view of the dental bur 1 viewed from the side of the cutting section 11. FIG, 1D is an end view of the dental bur 1 viewed from the side of the support section 12.

The dental bur 1 of FIGS. 1A-1D includes the cutting section 11. The cutting section 11 includes a spherical body 21 and diamond particles 9 coating the spherical body 21. The dental bur 1 is about 27 mm long from the end of the cutting section 11 to the end of the support section 12. The spherical body 21 has a diameter of about 1.5 mm. The neck section 13 includes a first taper portion 22 tapered at a relatively larger angle and a second taper portion 23 tapered at a relatively smaller angle. The first taper portion 22 is about 1 mm long and the second taper portion 23 is about 5 mm long. A junction between the first taper portion 22 and the second taper portion 23 has a diameter of about 1.0 mm. A junction between the second taper portion 23 and the spherical body 21 has a diameter of about 0.7 mm.

When a hole is drilled in a tooth missing portion of the jawbone using the dental bur 1, not only the end area of the cutting section 11 but also the rotating sidewall area of the cutting section 11 cuts jawbone. Even in the middle of the drilling operation, the angle of the hole is easily adjusted. Both ends of the first taper portion 22 in the neck section 13 serve as guides of the depth of the hole. The neck section 13 accommodates water flow supplied during the drilling operation, thereby preventing overheating on jawbone. The hole is thus reliably and safely drilled in the missing tooth section of the jawbone.

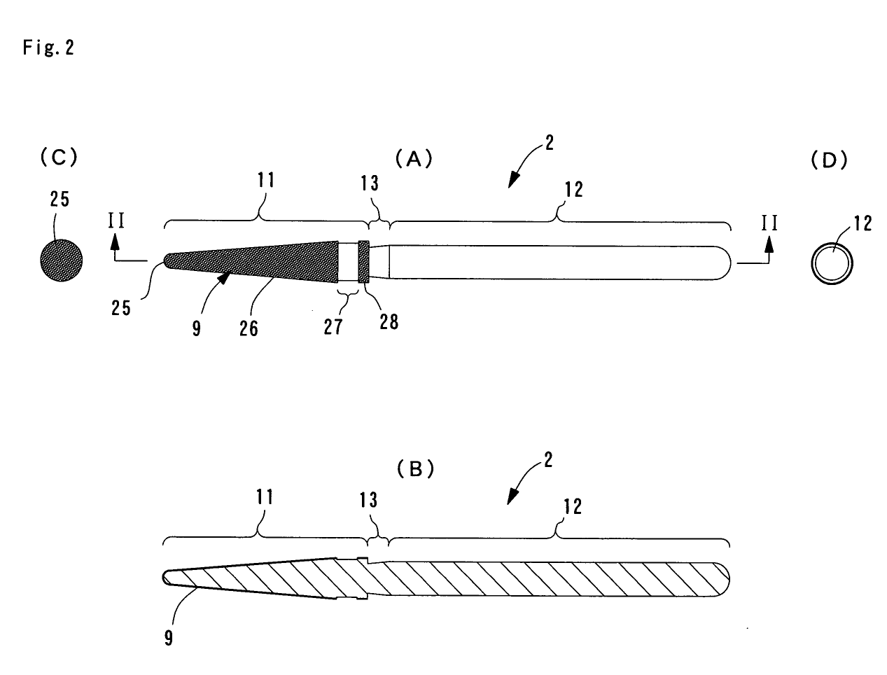

FIGS. 2A-2D illustrate another dental bur 2 in accordance with another embodiment of the present invention, different from the dental bur 1 of FIGS. 1A-1D. FIG. 2A is a plan view of the dental bur 2, FIG. 2B is a sectional view of the dental bur 2 taken along line II-II in FIG. 2A. FIG. 2C is an end view of the dental bur 2 viewed from the side of the cutting section 11. FIG. 2D is an end view of the dental bur 2 viewed from the side of the support section 12.

In the dental bur 2 of FIGS. 2A-2D, the cutting section 11 includes a round end portion 25, a taper portion 26 gradually tapered toward the end portion 25 and a ring portion 28 connected to the neck section 13. A second neck section 27 is formed between the taper portion 26 and the ring portion 28. The taper portion 26 including the end portion 25 and the ring portion 28 are coated with diamond particles 9. The dental bur 2 of FIGS. 2A-2D thus includes, in the cutting section 11 close to the support section 12, ring areas coated and uncoated with the diamond particles 9 alternately arranged along the longitudinal direction of the cutting section 11.

The dental bur 2 is about 27 mm long from the end of the cutting section 11 to the end of the support section 12 excluding the round end portion 25. The cutting section 11 is about 9.6 mm long excluding the round end portion 25. The taper portion 26 is about 8.1 mm long, the second neck section 27 is about 1 mm long and the ring portion 28 is about 0.5 mm long. The taper portion 26 has the largest diameter of about 1.6 mm. The round end portion 25 has a diameter of about 0.7 mm. The neck section 13 is about 1 mm long.

When a hole is drilled in a tooth missing portion of the jawbone using the dental bur 2, not only the end portion 25 of the taper portion 26 but also the rotating sidewall area of the taper portion 26 cuts jawbone. Even in the middle of the drilling operation, the angle of the hole is easily adjusted. Both ends of each of the neck section 13 and the second neck section 27 and the ring portion 28 serve as guides of the depth of the hole. The neck section 13 and the second neck section 27 accommodate water flow supplied during the drilling operation, thereby preventing overheating on jawbone. The hole is thus reliably and safely drilled in the missing tooth section of the jawbone.

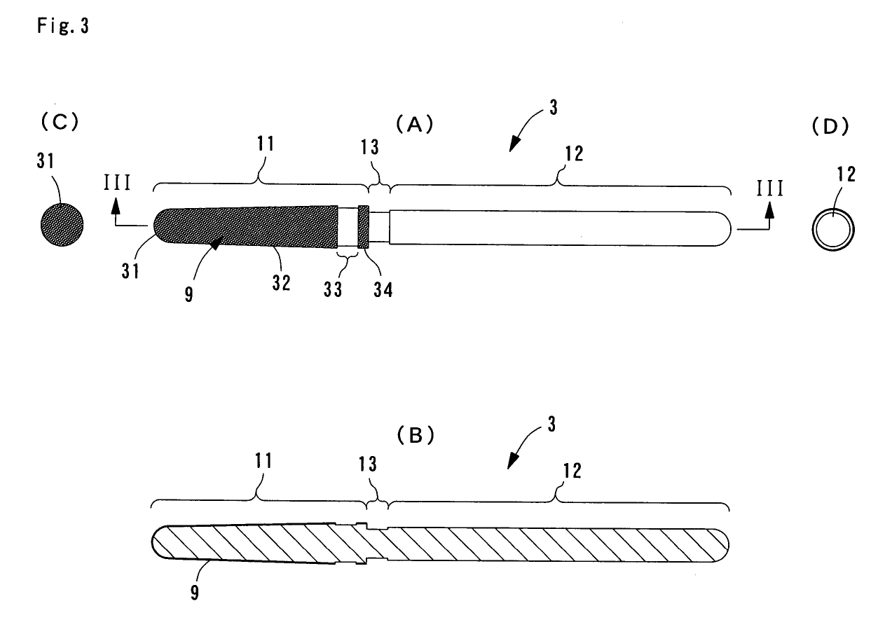

FIGS. 3A-3D illustrate another dental bur 3 in accordance with another embodiment of the present invention. FIG. 3A is a plan view of the dental bur 3, FIG. 3B is a sectional view of the dental bur 3 taken along line III-III in FIG. 3A. FIG. 3C is an end view of the dental bur 3 viewed from the side of the cutting section 11. FIG. 3D is an end view of the dental bur 3 viewed from the side of the support section 12.

The dental bur 3 is similar in structure to the dental bur 2 of FIGS. 2A-2D. In the dental bur 3 of FIGS. 3A-3D, the cutting section 11 includes a round end portion 31, a taper portion 32 gradually tapered toward the end portion 31 and a ring portion 34 connected to the neck section 13. A second neck section 33 is formed between the taper portion 32 and the ring portion 34. The taper portion 32 including the end portion 31 and the ring portion 34 are coated with diamond particles 9. The dental bur 3 of FIGS. 3A-3D thus includes, in the cutting section 11 close to the support section 12, ring areas coated and uncoated with the diamond particles 9 alternately arranged along the longitudinal direction of the cutting section 11.

The taper portion 32 of the dental bur 3 has the largest diameter of about 2 mm. The round end portion 31 has a diameter of about 1.6 mm. In comparison with the dental bur 2 of FIGS. 2A-2D, the taper portion 32 in the dental bur 3 is tapered at an angle milder than the taper portion 26 in the dental bur 2. The taper portion 32 of the cutting section 11 is substantially cylindrical. The dental bur 3 of FIGS. 3A-3D is more appropriate for drilling a hole having a cylindrical shape than the dental bur 2 of FIGS. 2A-2D.

When a hole is drilled in a tooth missing portion of the jawbone using the dental bur 3, not only the end portion 31 of the taper portion 32 but also the rotating sidewall area of the taper portion 32 cuts jawbone. Even in the middle of the drilling operation, the angle of the hole is easily adjusted. Both ends of each of the neck section 13 and the second neck section 33 and the ring portion 34 serve as guides of the depth of the hole. The neck section 13 and the second neck section 33 accommodate water flow supplied during the drilling operation, thereby preventing overheating on jawbone. The hole is thus reliably and safely drilled in the missing tooth section of the jawbone.

A hole is drilled in the jawbone to embed implants using the dental burs 1, 2, and 3 as described below, for example. An initial hole is drilled in a planned implant position using the dental bur 1 of FIGS. 1A-1D. The hole is further deepened to a depth required for the planned implant using the dental bur 2 of FIGS. 2A-2D. The hole is then widened in diameter using the dental bur 3 of FIGS. 3A-3D. Throughout the drilling operation, cooling water is continuously supplied to the hole. In particular, when the hole is drilled to a required depth using the dental bur 2 and the dental bur 3, the neck section 13 serves as a guide to the depth of the hole. Without using the depth gauge, the hole having the required depth is reliably drilled. Since the sidewall of the hole is also cut with the diamond particles 9 on the cutting section 11, the angle of the hole is relatively easily adjusted in the middle of the drilling operation.

After drilling the hole using the dental burs 1, 2, and 3, conventional twist drills having large diameters are successively used to form the hole adapted for the dental implant. For-example, a twist drill having a diameter within a range of 3 mm to 5 mm may be used.

In accordance with embodiments of the present invention, the dental burs 1, 2, and 3 are used at an initial phase of hole drilling prior to the drilling operation of the conventional twist drills and easily adjust the angle of the hole at the initial phase of the drilling operation.

Diamond particles 9 can come off and remain in the hole after the use of the dental burs 1, 2, and 3 of the embodiments of the present invention. The conventional twist drills having the large diameters are used subsequent of the drilling operation of the dental burs 1, 2, and 3, and the diamond particles 9 residing in the jawbone are reliably removed from the hole. This procedure controls the diamond particles 9 from residing in the jawbone.

As described above, with the dental burs 1, 2, and 3 of the embodiments of the present invention, the angle of the hole is easily adjusted. The implant hole is thus reliably and safely drilled.

What is claimed is:

1. A dental bur comprising a cutting section on one side thereof, a support section on the other side thereof and a neck section connecting the cutting section to the support section, the cutting section having a spherical shape and having a predetermined radius and coated with diamond particles.

2. A dental bur comprising a cutting section on one side thereof, a support section on the other side thereof and a neck section connecting the cutting section to the support section, the cutting section tapered toward the end thereof, terminated in a round shape, and coated with diamond particles.

3. A dental bur according to claim 2, wherein the cutting section has, on the surface closer to the support section, a first ring area and a second ring area alternately arranged along the longitudinal direction of the cutting section, the first ring area coated with diamond particles and the second ring area uncoated with diamond particles.

4. A method of drilling a hole receiving an implant, using first, second and third dental burs, the method comprising a step of using the first dental bur, the second dental bur and the third dental bur in that order to drill an initial hole at a planned position in jawbone, wherein the first dental bur comprises at one end thereof a spherical body coated with diamond particles, wherein the second dental bur comprises a cutting section having a tapered portion ended in a spherical shape, the tapered section coated with diamond particles, and wherein the third dental bur comprises a section tapered at a milder inclination than the second dental bur and ended in a spherical shape, the tapered section coated with diamond particles.
